(19) United States
(12) Patent Application Publication
(10) Pub. No.: US 2016/0063153 A1
(43) Pub. Date: Mar. 3, 2016

(54) SIMULATION METHOD AND APPARATUS FOR WIND FARM COMMON COUPLING REGION

(71) Applicants: TSINGHUA UNIVERSITY, Beijing (CN); STATE GRID CORPORATION OF CHINA, Beijing (CN); STATE GRID JIBEI ELECTRIC POWER COMPANY LIMITED, Beijing (CN)

(72) Inventors: QINGLAI GUO, Beijing (CN); HAIBO LAN, Beijing (CN); HONGBIN SUN, Beijing (CN); HAITAO LIU, Beijing (CN); BIN WANG, Beijing (CN); ZHE WANG, Beijing (CN); BOMING ZHANG, Beijing (CN); WENCHUAN WU, Beijing (CN); FENGDA XU, Beijing (CN)

(21) Appl. No.: 14/833,070

(22) Filed: Aug. 22, 2015

(30) Foreign Application Priority Data
Aug. 29, 2014 (CN) 201410436862.9

(51) Int. Cl. G06F 17/50; G06F 17/10

(52) U.S. Cl. CPC G06F 17/5009; G06F 17/10

(57) ABSTRACT

The present disclosure relates to a simulation method and simulation apparatus for a wind farm common coupling region. The simulation method includes: obtaining main network data calculated in a previous simulation period as initial values for performing a main network simulation in a current simulation period; obtaining sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm; performing the main network simulation and the sub-network simulation in parallel in the current simulation period.

### CROSS-REFERENCE TO RELATED APPLICATION

This application claims priority to and benefits of Chinese Patent Application No. 201410436862.9, filed with the State Intellectual Property Office of P. R. China on Aug. 29, 2014, the entire contents of which are incorporated herein by reference.

### FIELD

The present disclosure relates to a field of a simulation for a wind farm common coupling region in a power system, and more particularly relates to a simulation method for a wind farm common coupling region and a simulation apparatus for a wind farm common coupling region.

### BACKGROUND

In recent years, there are many accidents of multiple wind farms cascading trip-off due to the voltage induction happened in the wind farm common coupling region, thus, the temporal quasi-steady simulation of the power grid in the wind farm common coupling region is considered to be an effective method of analyzing the safety state of the voltage in the power system and preventing the accident from diffusing.

Unlike the conventional fire and water farm common coupling region, the wind farm common coupling region may include sub-networks of various wind farms, such that besides a flow calculation of the main network, flow calculations of the sub-networks and calculations of changes on related physical quantities of devices in the various wind farms are required to be performed. And the calculation results of the main network, the sub-networks of the various wind farms and devices in the various wind farms are matched with each other.

However, in the conventional temporal simulation system, a centralized model of whole network is often established, in which various kinds of devices have transient models. Since the model of the main network and the models of the sub-networks in the wind farm common coupling region are separated and heavy burdens may be brought to a computer due to the transient simulation calculations for a large number of wind turbines in the various wind farms, the conventional temporal simulation methods are not suitable for performing a simulation calculations on the wind farm common coupling regions for a long time.

### SUMMARY

Embodiments of the present invention seek to solve at least one of the problems existing in the prior art.

According to a first aspect of embodiments of the present disclosure, there is provided a simulation method for a wind farm common coupling region, including: obtaining main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes; obtaining sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm; performing the main network simulation and the sub-network simulation in parallel in the current simulation period according to the initial values for performing a main network simulation and the initial values for performing a sub-network simulation.

According to a second aspect of embodiments of the present disclosure, there is provided a simulation apparatus for a wind farm common coupling region, including: a processor; and a memory for storing instructions executable by the processor; in which the processor is configured to obtain main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes; obtain sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm; perform the main network simulation and the sub-network simulation in parallel in the current simulation period according to the initial values for performing a main network simulation and the initial values for performing a sub-network simulation.

According to a third aspect of embodiments of the present disclosure, there is provided a non-transitory computer-readable storage medium having stored therein instructions that, when executed by a processor of a computer, causes the computer to perform a simulation method for a wind farm common coupling region, the simulation method including: obtaining main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes; obtaining sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm; performing the main network simulation and the sub-network simulation in parallel in the current simulation period according to the initial values for performing a main network simulation and the initial values for performing a sub-network simulation.

The technical solutions provided by embodiments of the present disclosure have following advantageous effects.

(1) Comparing with the conventional temporal simulation methods, the computational burdens may be reduced by calculating in parallel and using an approximation of the quasi-steady model, and the simulation speed may be promoted. Further the technical solutions are suitable for simulating the dynamic characteristics of the wind farm common coupling region in a long time, thus suiting the requirements of quasi-steady simulations of the wind farm common coupling region.

(2) A structure that the simulation calculation of the main network and simulation calculations of the sub-networks in the wind farm common coupling region are separated may be established; therefore the simulation of the wind farm common coupling region may take into account the electrical coupling relationships of multiple wind farms, the fine network structure of each wind farm, and characteristics in the quasi steady processes of various devices in each wind farm.

It is to be understood that both the foregoing general description and the following detailed description are exemplary and explanatory only and are not restrictive of the invention, as claimed.

### BRIEF DESCRIPTION OF THE DRAWINGS

In order to explicitly illustrate embodiments of the present disclosure, a brief introduction for the accompanying drawings corresponding to the embodiments will be listed as follows. Apparently, the drawings described below are only corresponding to some embodiments of the present disclosure, and those skilled in the art may obtain other drawings according to these drawings without creative labor.

FIG. 1 is a flow chart showing a simulation method for a wind farm common coupling region according to an exemplary embodiment.

Embodiments of the present disclosure have already been illustrated with reference to above drawings, and will be described more detail in the following description. These drawings and text description are not intended to limit the scope of the present disclosure in any way, but are used to explain the concept of the present disclosure to those skilled in the art with reference to special embodiments.

### DETAILED DESCRIPTION

In order to make objectives, technical solutions and advantages of the present disclosure clearer, in the following the present disclosure will be described in detail with reference to drawings. Apparently, the described embodiments are only some embodiments of the present disclosure and do not represent all the embodiments. Based on the embodiment described herein, all the other embodiments obtained by those skilled in the art without creative labor belong to the protection scope of the present disclosure.

A simulation method for a wind farm common coupling region may be provides in embodiments of the present disclosure, in which the simulation method for a wind farm common coupling region may includes steps of: simulating a main network of the wind farm common coupling region and simulating sub-network of each wind farm in the wind farm common coupling region respectively and in parallel, in which simulating sub-network of each wind farm in the wind farm common coupling region includes steps of: performing a first power flow calculation for the sub-network of each wind farm and calculating quasi-steady models of devices in each wind farm.

In this embodiment, simulation calculations may be in parallel and respective, in other words, a structure that the simulation calculation of the main network in the wind farm common coupling region and the simulation calculations of the sub-networks of the various wind farms in the wind farm common coupling region are separated may be established.

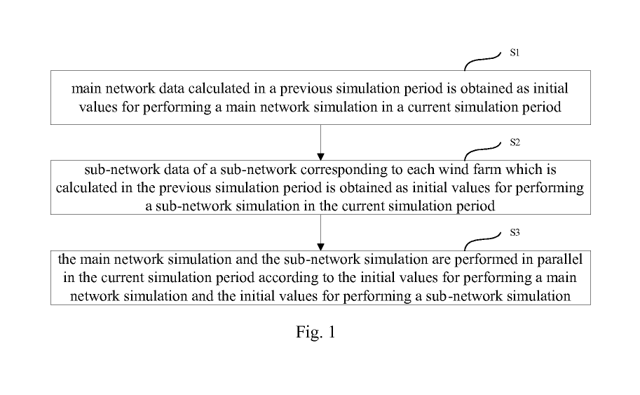

FIG. 1 is a flow chart showing a simulation method for a wind farm common coupling region according to an exemplary embodiment. As shown in FIG. 1, the simulation method includes following steps.

In step S1, main network data calculated in a previous simulation period is obtained as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes.

In step S2, sub-network data of a sub-network corresponding to each wind farm which is calculated in the previous simulation period is obtained as initial values for performing a sub-network simulation in the current simulation period, in which the sub-network data of the sub-network corresponding to each wind farm comprises terminal voltage amplitudes of wind turbines and static reactive power compensation devices in each wind farm.

In step S3, the main network simulation and the sub-network simulation are performed in parallel in the current simulation period according to the initial values for performing a main network simulation and the initial values for performing a sub-network simulation.

Therefore, the simulation method includes the main network simulation and the sub-network simulation in each simulation period. And the main network simulation and the sub-network simulation are performed in parallel. The simulation period is set as 10 milliseconds magnitude (the value range is within the semiperiod corresponding to 50 Hz frequency and various types of protective action delays, in this embodiment, the simulation period is set as 10 milliseconds).

The main network simulation and the sub-network simulation are performed in parallel for a plurality of numbers of times.

The main network simulation is performed for a I^{th} time by following steps.

(1) Sub-network simulation data calculated in a (I−1)^{th} sub-network simulation in the current simulation period is obtained to modify a power injection of each wind farm access node in the main network if I>1, in which the sub-network simulation data comprises a power vector S_{I-1} indicating active powers and reactive powers of each wind farm and obtained in the (I−1)^{th} sub-network simulation, the power injection is a sum of the active powers and reactive powers of each export of each wind farm.

(2) A first power flow calculation for the main network is performed to obtain a voltage vector U_{I} of wind farm access nodes according to the initial values for performing a main network simulation or according to the sub-network simulation data, in which the voltage vector U_{I} includes the amplitudes and phase angles of the voltages of wind farm access nodes and is obtained in a I^{th} sub-network simulation.

(3) A per unit normalization is performed on the voltage vector U_{I} and a voltage vector U_{I-1} of the wind farm access nodes calculated in a (I−1)^{th} main network simulation.

(4) It is judged whether ∥U_{I}−U_{I-1}∥∞≦ε or I≧Iₘₐₓ, where ε is a maximal tolerance deviation, and Iₘₐₓ, is a maximal number of times of the main network simulation, U₀ is 1. In this embodiment, ε may be 1e-4˜1e-5.

(5) The main network simulation and the sub-network simulation in the current simulation period are finished and a simulation result for the I^{th} main network simulation is output, if ∥U_{I}−U_{I-1}∥∞≦ε or I≧Iₘₐₓ, in which the simulation result comprises all results obtained in the I^{th} main network simulation and in the I^{th} sub-network simulation. The main network simulation and the sub-network simulation in the next simulation period are followed.

(6) A (I+1)^{th} main network simulation and a (I+1)^{th} sub-network simulation are performed, if ∥U_{I}−U_{I-1}∥∞>ε and I<Iₘₐₓ.

The sub-network simulation is performed for a I^{th} time by following steps.

(1) The sub-network data of the sub-network corresponding to each wind farm in the (I−1)^{th} sub-network simulation is obtained as replacement values if I>1.

(2) Quasi-steady models of devices in each wind farm are established according to the initial values for performing a sub-network simulation and preset reference values if I=1, or according to the initial values for performing a sub-network simulation, the replacement values and preset reference values if I>1. Specifically, if I>1, the voltage input u_{I-1} in the quasi-steady models established in the (I−1)^{th} sub-network simulation are modified with the replacement values to establish the quasi-steady models in the I^{th} sub-network simulation, in which u_{I-1} represents terminal voltage vector of devices in each wind farm and is obtained in the (I−1)^{th} sub-network simulation, and the preset reference values comprises a first reference value p_{WTG,ref} representing an active power of each wind turbine, a second reference value q_{WTG,ref} representing a reactive power of each wind turbine, a third reference value U_{SVS,ref} representing a voltage of each static reactive power compensation device, a fourth reference value q_{SVS,ref} representing a reactive power of each static reactive power compensation device. The preset reference values are set by an external control program or manually. And these preset reference values do not exceed volume limits and voltage limits.

(3) The quasi-steady models under a normal state and a protection state are solved to obtain output powers of the devices in each wind farm.

(4) A voltage amplitude and a phase angle of an extranet equivalent balance node of the sub-network corresponding to each wind farm is modified according to the voltage vector U_{I-1} of the wind farm access node,
(5) A second power flow calculation for the sub-network corresponding to each wind farm is performed to obtain a power vector S_{I}, in which the power vector S_{I} indicates active powers and reactive powers of each wind farm and is obtained in the i^{th} sub-network simulation.

In some embodiments, the quasi-steady models under a normal state are solved by calculating an output power of a wind turbine under the normal state and calculating an output power of a static reactive power compensation device under the normal state.

The output power of a wind turbine under the normal state is calculated according to following steps.

(1) A reference value e_{WTG,qref,I} of an equivalent quadrature axis electrodynamic force of the wind turbine is calculated according to formula (1):

$${e}_{WTG , qref , I} = \frac{{p}_{WTG , ref} {x}_{WTG}}{{u}_{WTG , I}} , \qquad ( 1 )$$

where u_{WTG,I} represents a terminal voltage of the wind turbine and is a component of u_{I}, and x_{WFG} represents a contact reactance determined by the wind turbine and controller parameters of the wind turbine.

(2) An equivalent quadrature axis electrodynamic force e_{WTG,I} of the wind turbine is calculated according to formula (2):

$${e}_{WTG , q , I} = \frac{{e}_{WTG , qref , I}}{1 + {T}_{WTG} \cdot s} , \qquad ( 2 )$$

where T_{WTG} represents a time constant determined by the controller parameters of the wind turbine, and s represents a Laplasse operator.

(3) A reference value e_{WTG,dref,I} of an equivalent direct axis electrodynamic force of the wind turbine is calculated according to formula (3):

$${e}_{WTG , dref , I} = \frac{{q}_{WTG , ref} {x}_{WTG}}{{u}_{WTG , I}} + {u}_{WTG , I} . \qquad ( 3 )$$

(4) An equivalent direct axis electrodynamic force e_{WTG,d,I} of the wind turbine is calculated according to formula (4):

$${e}_{WTG , d , I} = \frac{{e}_{WTG , dref , I}}{1 + {T}_{WTG} \cdot s} . \qquad ( 4 )$$

(5) An active power p_{WTG,I} of the wind turbine is calculated according to formula (5):

$${p}_{WTG , I} = \frac{{e}_{WTG , q , I} {u}_{WTG , I}}{{x}_{WTG}} , \qquad ( 5 )$$

a reactive power q_{WTG,I} of the wind turbine is calculated according to formula (6):

$${q}_{WTG , I} = \frac{{e}_{WTG , d , I} {u}_{WTG , I}}{{x}_{WTG}} - \frac{{u}_{WTG , I}^{2}}{{x}_{WTG}} . \qquad ( 6 )$$

(6) The output power of the wind turbine under the normal state is obtained according to a formula of s_{WTG,I}=p_{WTG,I}+jq_{WTG,I}, the power s_{WTG,I} is a component of s_{I} and j is a imaginary symbol.

In some embodiments, an output power of a static reactive power compensation device under the normal state is calculated according to following steps.

(1) If the static reactive power compensation device is in a constant voltage control mode, a reactive power reference value q_{SVS,ref} is calculated according to formula (7):

$${q}_{SVS , ref} = - ( {K}_{SVS , P} + \frac{{K}_{SVS , I}}{s} + {K}_{SVS , D} s ) ( {u}_{SVS , I} - {u}_{SVS , ref} ) , \qquad ( 7 )$$

where u_{SVS,I} represents a terminal voltage of the static reactive power compensation device and is a component of u_{I}, K_{SVS,P}, K_{SVS,I} and K_{SVS,D} are coefficients in a proportional computation, an integral computation and a differential computation respectively and determined by a controller parameters of the static reactive power compensation device.

(2) an equivalent reactance reference value X_{SVS,ref,I} of the static reactive power compensation device is calculated according to formula (8):

$${x}_{SVS , ref , I} = \frac{{u}_{SVS , I}^{2}}{{q}_{SVS , ref}} . \qquad ( 8 )$$

(3) an equivalent reactance x_{SVS,I} of the static reactive power compensation device is calculated according to formula (9):

$${x}_{SVS , I} = \frac{{x}_{SVS , ref , I}}{1 + {T}_{SVS} \cdot s} , \qquad ( 9 )$$

where T_{SVS} represents a time constant determined by the controller parameters of the static reactive power compensation device.

(4) a reactive power q_{SVS,I} of the static reactive power compensation device is calculated according to formula (10):

$${q}_{SVS , I} = \frac{{u}_{SVS , I}^{2}}{{x}_{SVS , I}} . \qquad ( 10 )$$

(5) The output power of the static reactive power compensation device under the normal state is obtained according to a formula of s_{SVS,I}=jq_{SVS,I}, in which the power s_{SVS,I} is a component of s_{I}.

In some embodiments, a quasi-steady model of a device under the protection state is solved according to following steps.

(1) A protection start preparation time of the device is obtained, in which an initial value of the protection start preparation time is 0, the protection start preparation time is added to a time interval if a terminal voltage of the device is greater than an upper limit or is less than a lower limit, and the protection start preparation time period is set as 0 if the terminal voltage of the device is between the an upper limit and the lower limit.

(2) it is determined that the device is off-network, and setting the output power of the device as 0, if the protection start preparation time is greater than a predetermined time period.

In this embodiment, the temporal quasi-steady simulation of the wind farm common coupling region refers to a simulation of the change process of the physical quantities (such as voltages, powers) performed using calculation models by establishing the quasi-steady models of devices (wind turbines, static reactive power compensation devices and static reactive power generators) in the wind farms and the static models of internal networks of the wind farms and the wind farm common coupling region network.

It should be noted that, in embodiments of the present disclosure, the power flow calculation involved aims to solve a set of nonlinear algebraic equations represented by the flow equations.

In order to realize the above embodiments, a simulation apparatus for a wind farm region is provided.

The simulation apparatus for a wind farm common coupling region, including: a processor; and a memory for storing instructions executable by the processor; in which the processor is configured to obtain main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes; obtain sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm; perform the main network simulation and the sub-network simulation in parallel in the current simulation period according to the initial values for performing a main network simulation and the initial values for performing a sub-network simulation.

In some embodiments, the main network simulation and the sub-network simulation are performed in parallel for a plurality of numbers of times, the processor is configured to perform the main network simulation for a I^{th} time by:

obtaining sub-network simulation data calculated in a (I−1)^{th} sub-network simulation in the current simulation period to modify a power injection of each wind farm access node in the main network if I>1, in which the sub-network simulation data comprises a power vector S_{I-1} indicating active powers and reactive powers of each wind farm and obtained in the (I−1)^{th} sub-network simulation, the power injection is a sum of the active powers and reactive powers of each wind farm;

performing a first power flow calculation for the main network to obtain a voltage vector U_{I} of wind farm access nodes according to the initial values for performing a main network simulation or according to the sub-network simulation data, in which the voltage vector U_{I} comprises the amplitudes and phase angles of the voltages of wind farm access nodes and is obtained in a I^{th} sub-network simulation;

performing a per unit normalization on the voltage vector U_{I} and a voltage vector U_{I-1} of the wind farm access nodes calculated in a (I−1)^{th} main network simulation;

judging whether ∥U_{I}−U_{I-1}∥∞≦ε or I≧Iₘₐₓ, where ε is a maximal tolerance deviation, and Iₘₐₓ is a maximal number of times of the main network simulation;

stopping performing the main network simulation and the sub-network simulation in the current simulation period and outputting a simulation result for the I^{th} main network simulation, if ∥U_{I}−U_{I-1}∥∞≦ε or I≧Iₘₐₓ, in which the simulation result comprises all results obtained in the I^{th} main network simulation and in the I^{th} sub-network simulation;

performing a (I+1)^{th} main network simulation and a (I+1)^{th} sub-network simulation, if ∥U_{I}−U_{I-1}∥∞>ε and I<Iₘₐₓ;

In some embodiments, the processor is configured to perform the sub-network simulation for a I^{th} time by:

obtaining the sub-network data of the sub-network corresponding to each wind farm in the (I−1)^{th} sub-network simulation as replacement values if I>1;

establishing quasi-steady models of devices in each wind farm according to the initial values for performing a sub-network simulation and preset reference values if I=1, or according to the initial values for performing a sub-network simulation, the replacement values and the preset reference values if I>1, in which the preset reference values comprises a first reference value P_{WTG,ref} representing an active power of each wind turbine, a second reference value q_{WTG,ref} representing a reactive power of each wind turbine, a third reference value u_{SVS,ref} representing a voltage of each static reactive power compensation device, a fourth reference value q_{SVS,ref} representing a reactive power of each static reactive power compensation device;

solving the quasi-steady models under a normal state and a protection state to obtain a quasi-steady result s_{I};

modifying a voltage amplitude and a phase angle of an extranet equivalent balance node of the sub-network corresponding to each wind farm according to the voltage vector U_{I-1} of the wind farm access node;

performing a second power flow calculation for the sub-network corresponding to each wind farm to obtain a power vector S_{I}, in which the power vector S_{I} indicates active powers and reactive powers of each wind farm and is obtained in the I^{th} sub-network simulation.

In some embodiments, the processor is configured to solve the quasi-steady models under a normal state by calculating an output power of a wind turbine under the normal state and calculating an output power of a static reactive power compensation device under the normal state.

The output power of a wind turbine under the normal state is calculated by:
calculating a reference value e_{WTG,qref,I} of an equivalent quadrature axis electrodynamic force of the wind turbine according to formula (1):

$${e}_{WTG , qref , I} = \frac{{p}_{WTG , ref} {x}_{WTG}}{{u}_{WTG , I}} , \qquad ( 1 )$$

where u_{WTG,I} represents a terminal voltage of the wind turbine and is a component of u_{I}, and x_{WTG} represents a contact reactance determined by the wind turbine and controller parameters of the wind turbine;
calculating an equivalent quadrature axis electrodynamic force e_{WTG,q,I} of the wind turbine according to formula (2):

$${e}_{WTG , q , I} = \frac{{e}_{WTG , qref , I}}{1 + {T}_{WTG} \cdot s} , \qquad ( 2 )$$

where T_{WTG} represents a time constant determined by the controller parameters of the wind turbine, and s represents a Laplasse operator;
calculating a reference value er, e_{WTG,dref,I} of an equivalent direct axis electrodynamic force of the wind turbine according to formula (3):

$${e}_{WTG , dref , I} = \frac{{q}_{WTG , ref} {x}_{WTG}}{{u}_{WTG , I}} + {u}_{WTG , I} , \qquad ( 3 )$$

calculating an equivalent direct axis electrodynamic force e_{WTG,d,I} of the wind turbine according to formula (4):

$${e}_{WTG , d , I} = \frac{{e}_{WTG , dref , I}}{1 + {T}_{WTG} \cdot s} , \qquad ( 4 )$$

calculating an active power P_{WTG,I} of the wind turbine according to formula (5):

$${p}_{WTG , I} = \frac{{e}_{WTG , q , I} {u}_{WTG , I}}{{x}_{WTG}} , \qquad ( 5 )$$

calculating a reactive power q_{WTG,I} of the wind turbine according to formula (6):

$${q}_{WTG , I} = \frac{{e}_{WTG , d , I} {u}_{WTG , I}}{{x}_{WTG}} - \frac{{u}_{WTG , I}^{2}}{{x}_{WTG}} , \qquad ( 6 )$$

obtaining the output power of the wind turbine under the normal state according to a formula of s_{WTG,I}=p_{WTG,I}+jq_{WTG,I}, the power s_{WTG,I} is a component of s_{I} and j is a imaginary symbol.

The output power of a static reactive power compensation device under the normal state is calculated by:
calculating a reactive power reference value q_{SVS,ref} according to formula (7) if the static reactive power compensation device is on a constant voltage control mode:

$${q}_{SVS , ref} = - ( {K}_{SVS , P} + \frac{{K}_{SVS , I}}{s} + {K}_{SVS , D} s ) ( {u}_{SVS , I} - {u}_{SVS , ref} ) , \qquad ( 7 )$$

where u_{SVS,I} represents a terminal voltage of the static reactive power compensation device and is a component of u_{I}, K_{SVS,P}, K_{SVS,I} and K_{SVS,D} are coefficients in a proportional computation, an integral computation and a differential computation respectively and determined by a controller parameters of the static reactive power compensation device;
calculating an equivalent reactance reference value x_{SVS,ref,I} of the static reactive power compensation device according to formula (8):

$${x}_{SVS , ref , I} = \frac{{u}_{SVS , I}^{2}}{{q}_{SVS , ref}} \qquad ( 8 )$$

calculating an equivalent reactance x_{SVS,I} of the static reactive power compensation device according to formula (9):

$${x}_{SVS , I} = \frac{{x}_{SVS , ref , I}}{1 + {T}_{SVS} \cdot s} \qquad ( 9 )$$

where T_{SVS} represents a time constant determined by the controller parameters of the static reactive power compensation device;
calculating a reactive power q_{SVS,I} of the static reactive power compensation device according to formula (10):

$${q}_{SVS , I} = \frac{{u}_{SVS , I}^{2}}{{x}_{SVS , I}} \qquad ( 10 )$$

obtaining the output power of the static reactive power compensation device under the normal state according to a formula of s_{SVS,I}=jq_{SVS,I}, in which the power s_{SVS,I} is a component of s_{I}.

In some embodiments, the processor is configured to solve a quasi-steady model of a device under the protection state by steps of: obtaining a protection start preparation time of the device, wherein an initial value of the protection start preparation time is 0, the protection start preparation time is added to a time interval if a terminal voltage of the device is greater than an upper limit or is less than a lower limit, and the protection start preparation time period is set as 0 if the terminal voltage of the device is between the an upper limit and the lower limit; determining that the device is off-network, and setting the output power of the device as 0, if the protection start preparation time is greater than a predetermined time period.

In some embodiments, a simulation period is set as ten milliseconds.

In some embodiments, the non-transitory computer-readable storage medium having stored therein instructions that, when executed by a processor of a computer, causes the computer to perform a simulation method for a wind farm common coupling region for running an application program, in which the simulation method for a wind farm common coupling region is according to the above embodiments of the present disclosure.

The technical solutions provided by embodiments of the present disclosure have following advantageous effects.

(1) Comparing with the conventional temporal simulation methods, the computational burdens may be reduced by calculating in parallel and using an approximation of the quasi-steady model, and the simulation speed may be promoted. Further the technical solutions are suitable for simulating the dynamic characteristics of the wind farm common coupling region in a long time, thus suiting the requirements of quasi-steady simulations of the wind farm common coupling region.

(2) A structure that the simulation calculation of the main network and simulation calculations of the sub-networks in the wind farm common coupling region are separated may be established; therefore the simulation of the wind farm common coupling region may take into account the electrical coupling relationships of multiple wind farms, the fine network structure of each wind farm, and characteristics in the quasi steady processes of various devices in each wind farm.

Any process or method described in the flowing diagram or other means may be understood as a module, segment or portion including one or more executable instruction codes of the procedures configured to achieve a certain logic function or process, and the preferred embodiments of the present disclosure include other performances, in which the performance may be achieved in other orders instead of the order shown or discussed, such as in a almost simultaneous way or in an opposite order, which should be appreciated by those having ordinary skills in the art to which embodiments of the present disclosure belong.

The logic and/or procedures indicated in the flowing diagram or described in other means herein, such as a constant sequence table of the executable code for performing a logical function, may be implemented in any computer readable storage medium so as to be adopted by the code execution system, the device or the equipment (such a system based on the computer, a system including a processor or other systems fetching codes from the code execution system, the device and the equipment, and executing the codes) or to be combined with the code execution system, the device or the equipment to be used. With respect to the description of the present invention, “the computer readable storage medium” may include any device including, storing, communicating, propagating or transmitting program so as to be used by the code execution system, the device and the equipment or to be combined with the code execution system, the device or the equipment to be used. The computer readable medium includes specific examples (a non-exhaustive list): the connecting portion (electronic device) having one or more arrangements of wire, the portable computer disc cartridge (a magnetic device), the random access memory (RAM), the read only memory (ROM), the electrically programmable read only memory (EPROMM or the flash memory), the optical fiber device and the compact disk read only memory (CDROM). In addition, the computer readable storage medium even may be papers or other proper medium printed with program, as the papers or the proper medium may be optically scanned, then edited, interpreted or treated in other ways if necessary to obtain the program electronically which may be stored in the computer memory.

It should be understood that, each part of the present disclosure may be implemented by the hardware, software, firmware or the combination thereof. In the above embodiments of the present invention, the plurality of procedures or methods may be implemented by the software or hardware stored in the computer memory and executed by the proper code execution system. For example, if the plurality of procedures or methods is to be implemented by the hardware, like in another embodiment of the present invention, any one of the following known technologies or the combination thereof may be used, such as discrete logic circuits having logic gates for implementing various logic functions upon an application of one or more data signals, application specific integrated circuits having appropriate logic gates, programmable gate arrays (PGA), field programmable gate arrays (FPGA).

It can be understood by those having the ordinary skills in the related art that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The non-transitory computer-readable storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A simulation method for a wind farm common coupling region, comprising:
obtaining main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes;
obtaining sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm;
performing the main network simulation and the sub-network simulation in parallel in the current simulation period according to the initial values for performing a main network simulation and the initial values for performing a sub-network simulation.

2. The simulation method according to claim 1, wherein the main network simulation and the sub-network simulation are performed in parallel for a plurality of numbers of times;
wherein the main network simulation is performed for a I^{th} time by steps of:
obtaining sub-network simulation data calculated in a (I−1)^{th} sub-network simulation in the current simulation period to modify a power injection of each wind farm access node in the main network if I>1, in which the sub-network simulation data comprises a power vector S_{I-1} indicating active powers and reactive powers of each wind farm and obtained in the (I−1)^{th} sub-network simulation
, the power injection is a sum of the active powers and reactive powers of each wind farm;
performing a first power flow calculation for the main network to obtain a voltage vector U_{I} of wind farm access nodes according to the initial values for performing a main network simulation or according to the sub-network simulation data, in which the voltage vector U_{I} comprises the amplitudes and phase angles of the voltages of wind farm access nodes and is obtained in a I^{th} sub-network simulation;
performing a per unit normalization on the voltage vector U_{I} and a voltage vector U_{I-1} of the wind farm access nodes calculated in a (I−1)^{th} main network simulation;
judging whether ∥U_{I}−U_{I-1}∥∞≦ε or I≧Iₘₐₓ, where ε is a maximal tolerance deviation, and Iₘₐₓ is a maximal number of times of the main network simulation;
stopping performing the main network simulation and the sub-network simulation in the current simulation period and outputting a simulation result for the I^{th} main network simulation, if ∥U_{I}−U_{I-1}∥∞≦ε or I≧Iₘₐₓ, in which the simulation result comprises all results obtained in the I^{th} main network simulation and in the I^{th} sub-network simulation;
performing a (I+1)^{th} main network simulation and a (I+1)^{th} sub-network simulation, if ∥U_{I}−U_{I-1}∥∞≦ε and I<Iₘₐₓ;
and
wherein the sub-network simulation is performed for a I^{th} time by steps of:
obtaining the sub-network data of the sub-network corresponding to each wind farm in the (I−1)^{th} sub-network simulation as replacement values if I>1;
establishing quasi-steady models of devices in each wind farm according to the initial values for performing a sub-network simulation and preset reference values if I=1, or according to the initial values for performing a sub-network simulation, the replacement values and preset reference values if I>1, in which the preset reference values comprise a first reference value P_{WTG,ref} representing an active power of each wind turbine, a second reference value q_{WTG,ref} representing a reactive power of each wind turbine, a third reference value U_{SVS,ref} representing a voltage of each static reactive power compensation device, a fourth reference value q_{SVS,ref}, representing a reactive power of each static reactive power compensation device;
solving the quasi-steady models under a normal state and a protection state to obtain a quasi-steady result s_{I};
modifying a voltage amplitude and a phase angle of an extranet equivalent balance node of the sub-network corresponding to each wind farm according to the voltage vector U_{I-1} of the wind farm access node;
performing a second power flow calculation for the sub-network corresponding to each wind farm to obtain a power vector S_{I}, in which the power vector S_{I} indicates active powers and reactive powers of each wind farm and is obtained in the I^{th} sub-network simulation.

3. The simulation method according to claim 2, wherein solving the quasi-steady models under a normal state comprises:
calculating an output power of a wind turbine under the normal state by:
calculating a reference value e_{WTG,q,ref,I} of an equivalent quadrature axis electrodynamic force of the wind turbine according to formula (1):
$${e}_{WTG , qref , I} = \frac{{p}_{WTG , ref} {x}_{WTG}}{{u}_{WTG , I}} , \qquad ( 1 )$$
where u_{WTG,I} represents a terminal voltage of the wind turbine and is a component of u_{I}, and x_{WTG} represents a contact reactance determined by the wind turbine and controller parameters of the wind turbine;
calculating an equivalent quadrature axis electrodynamic force e_{WTG,q,I} of the wind turbine according to formula (2):
$${e}_{WTG , q , I} = \frac{{e}_{WTG , qref , I}}{1 + {T}_{WTG} \cdot s} , \qquad ( 2 )$$
where T_{WTG} represents a time constant determined by the controller parameters of the wind turbine, and s represents a Laplasse operator;
calculating a reference value e_{WTG,dref,I} of an equivalent direct axis electrodynamic force of the wind turbine according to formula (3):
$${e}_{WTG , dref , I} = \frac{{q}_{WTG , ref} {x}_{WTG}}{{u}_{WTG , I}} + {u}_{WTG , I} , \qquad ( 3 )$$
calculating an equivalent direct axis electrodynamic force e_{WTG,d,I} of the wind turbine according to formula (4):
$${e}_{WTG , d , I} = \frac{{e}_{WTG , dref , I}}{1 + {T}_{WTG} \cdot s} , \qquad ( 4 )$$
calculating an active power p_{WTG,I} of the wind turbine according to formula (5):
$${p}_{WTG , I} = \frac{{e}_{WTG , q , I} {u}_{WTG , I}}{{x}_{WTG}} , \qquad ( 5 )$$
calculating a reactive power q_{WTG,I} of the wind turbine according to formula (6):
$${q}_{WTG , I} = \frac{{e}_{WTG , d , I} {u}_{WTG , I}}{{x}_{WTG}} - \frac{{u}_{WTG , I}^{2}}{{x}_{WTG}} , \qquad ( 6 )$$
obtaining the output power of the wind turbine under the normal state according to a formula of s_{WTG,I}=P_{WTG,I}+jq_{WTG,I}, the power S_{WTG,I} is a component of s_{I} and j is a imaginary symbol;
and
calculating an output power of a static reactive power compensation device under the normal state by:
calculating a reactive power reference value q_{SVS,ref} according to formula (7) if the static reactive power compensation device is in a constant voltage control mode:
$${q}_{SVS , ref} = - ( {K}_{SVS , P} + \frac{{K}_{SVS , I}}{S} + {K}_{SVS , {D}^{S}} ) ( {u}_{SVS , I} - {u}_{SVS , ref} ) , \qquad ( 7 )$$
where u_{SVS,I} represents a terminal voltage of the static reactive power compensation device and is a component of u_{I}, K_{SVS,P}, K_{SVS,I} and K_{SVS,D} are coefficients in a proportional computation, an integral computation and a differential computation respectively and are determined by controller parameters of the static reactive power compensation device;
calculating an equivalent reactance reference value x_{SVS,ref,I} of the static reactive power compensation device according to formula (8):
$${x}_{SVS , ref , I} = \frac{{u}_{SVS , I}^{2}}{{q}_{SVS , ref}} \qquad ( 8 )$$
calculating an equivalent reactance x_{SVS,I} of the static reactive power compensation device according to formula (9):
$${x}_{SVS , I} = \frac{{x}_{SVS , ref , I}}{1 + {T}_{SVS} \cdot s} \qquad ( 9 )$$
where T_{SVS} represents a time constant determined by the controller parameters of the static reactive power compensation device;
calculating a reactive power q_{SVS,I} of the static reactive power compensation device according to formula (10):
$${q}_{SVS , I} = \frac{{u}_{SVS , I}^{2}}{{x}_{SVS , I}} \qquad ( 10 )$$
obtaining the output power of the static reactive power compensation device under the normal state according to a formula of s_{SVS,I}=jq_{SVS,I}, in which the power s_{SVS,I} is a component of s_{I}.

4. The simulation method according to claim 3, wherein solving a quasi-steady model of a device under the protection state comprises:
obtaining a protection start preparation time of the device, wherein an initial value of the protection start preparation time is 0, the protection start preparation time is added to a time interval if a terminal voltage of the device is greater than an upper limit or is less than a lower limit, and the protection start preparation time period is set as 0 if the terminal voltage of the device is between the an upper limit and the lower limit;
determining that the device is tripping, and setting the output power of the device as 0, if the protection start preparation time is greater than a predetermined time period.

5. The simulation method according to claim 1, wherein a simulation period is set as ten milliseconds.

6. A simulation apparatus for a wind farm common coupling region, comprising:
a processor; and
a memory for storing instructions executable by the processor;
wherein the processor is configured to
obtain main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes;
obtain sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm;
perform the main network simulation and the sub-network simulation in parallel in the current simulation period according to the initial values for performing a main network simulation and the initial values for performing a sub-network simulation.

7. The simulation apparatus according to claim 6, wherein the main network simulation and the sub-network simulation are performed in parallel for a plurality of numbers of times;
the processor is configured to perform the main network simulation for a I^{th} time by:
obtaining sub-network simulation data calculated in a (I−1)^{th} sub-network simulation in the current simulation period to modify a power injection of each wind farm access node in the main network if I>1, in which the sub-network simulation data comprises a power vector S_{I-1} indicating active powers and reactive powers of each wind farm and obtained in the (I−1)^{th} sub-network simulation, the power injection is a sum of the active powers and reactive powers of each wind farm;
performing a first power flow calculation for the main network to obtain a voltage vector U_{I} of wind farm access nodes according to the initial values for performing a main network simulation or according to the sub-network simulation data, in which the voltage vector U_{I} comprises the amplitudes and phase angles of the voltages of wind farm access nodes and is obtained in a I^{th} sub-network simulation;
performing a per unit normalization on the voltage vector U_{I} and a voltage vector U_{I-1} of the wind farm access nodes calculated in a (I−1)^{th} main network simulation;
judging whether ∥U_{I}−U_{I-1}∥∞≦ε or I≧Iₘₐₓ, where ε is a maximal tolerance deviation, and Iₘₐₓ is a maximal number of times of the main network simulation;
stopping performing the main network simulation and the sub-network simulation in the current simulation period and outputting a simulation result for the I^{th} main network simulation, if ∥U_{I}−U_{I-1}∥∞≦ε or I≧Iₘₐₓ, in which the simulation result comprises all results obtained in the I^{th} main network simulation and in the I^{th} sub-network simulation;
performing a (I+1)^{th} main network simulation and a (I+1)^{th} sub-network simulation, if ∥U_{I}−U_{I-1}∥∞>ε and I<Iₘₐₓ;
and the processor is configured to perform the sub-network simulation for a I^{th} time by:
obtaining the sub-network data of the sub-network corresponding to each wind farm in the (I−1)^{th} sub-network simulation as replacement values if I>1;
establishing quasi-steady models of devices in each wind farm according to the initial values for performing a sub-network simulation and preset reference values if I=1, or according to the initial values for performing a sub-network simulation, the replacement values and the preset reference values if I>1, in which the preset reference values comprises a first reference value p_{WTG,ref} representing an active power of each wind turbine, a second reference value q_{WTG,ref} representing a reactive power of each wind turbine, a third reference value u_{SVS,ref} representing a voltage of each static reactive power compensation device, a fourth reference value q_{SVS,ref} representing a reactive power of each static reactive power compensation device;
solving the quasi-steady models under a normal state and a protection state to obtain a quasi-steady result s_{I};
modifying a voltage amplitude and a phase angle of an extranet equivalent balance node of the sub-network corresponding to each wind farm according to the voltage vector U_{I-1} of the wind farm access node;
performing a second power flow calculation for the sub-network corresponding to each wind farm to obtain a power vector S_{I}, in which the power vector S_{I} indicates active powers and reactive powers of each wind farm and is obtained in the I^{th} sub-network simulation.

8. The simulation apparatus according to claim 7, wherein the processor is configured to solve the quasi-steady models under a normal state by:
calculating an output power of a wind turbine under the normal state by:
calculating a reference value e_{WTG,qref,I} of an equivalent quadrature axis electrodynamic force of the wind turbine according to formula (1):
$${e}_{WTG , qref , I} = \frac{{p}_{WTG , ref} {x}_{WTG}}{{u}_{WTG , I}} , \qquad ( 1 )$$
where u_{WTG,I} represents a terminal voltage of the wind turbine and is a component of u_{I}, and x_{WTG} represents a contact reactance determined by the wind turbine and controller parameters of the wind turbine;
calculating an equivalent quadrature axis electrodynamic force e_{WTG,q,I} of the wind turbine according to formula (2):
$${e}_{WTG , q , I} = \frac{{e}_{WTG , qref , I}}{1 + {T}_{WTG} \cdot s} , \qquad ( 2 )$$
where T_{WTG} represents a time constant determined by the controller parameters of the wind turbine, and s represents a Laplasse operator;
calculating a reference value e_{WTG,dref,I} of an equivalent direct axis electrodynamic force of the wind turbine according to formula (3):
$${e}_{WTG , dref , I} = \frac{{q}_{WTG , ref} {x}_{WTG}}{{u}_{WTG , I}} + {u}_{WTG , I} , \qquad ( 3 )$$
calculating an equivalent direct axis electrodynamic force e_{WTG,d,I} of the wind turbine according to formula (4):
$${e}_{WTG , d , I} = \frac{{e}_{WTG , dref ,}}{1 + {T}_{WTG} \cdot s} , \qquad ( 4 )$$
calculating an active power p_{WTG,I} of the wind turbine according to formula (5):
$${p}_{WTG , I} = \frac{{e}_{WTG , q , I} {u}_{WTG , I}}{{x}_{WTG}} , \qquad ( 5 )$$
calculating a reactive power q_{WTG,I} of the wind turbine according to formula (6):
$${q}_{WTG , I} = \frac{{e}_{WTG , d ,} {u}_{WTG , I}}{{x}_{WTG}} - \frac{{u}_{WTG , I}^{2}}{{x}_{WTG}} , \qquad ( 6 )$$
obtaining the output power of the wind turbine under the normal state according to a formula of s_{WTG,I}=p_{WTG,I}+jq_{WTG,I}, the power S_{WTG,I} is a component of s_{I} and j is a imaginary symbol;
and
calculating an output power of a static reactive power compensation device under the normal state by:
calculating a reactive power reference value q_{SVS,ref} according to formula (7) if the static reactive power compensation device is on a constant voltage control mode:
$${q}_{SVS , ref} = - ( {K}_{SVS , P} + \frac{{K}_{SVS , I}}{S} + {K}_{SVS , {D}^{S}} ) ( {u}_{SVS , I} - {u}_{SVS , ref} ) , \qquad ( 7 )$$
where u_{SVS,I} represents a terminal voltage of the static reactive power compensation device and is a component of u_{I}, K_{SVS,P}, K_{SVS,I} and K_{SVS,D} are coefficients in a proportional computation, an integral computation and a differential computation respectively and are determined by a controller parameters of the static reactive power compensation device;
calculating an equivalent reactance reference value x_{SVS,ref,I} of the static reactive power compensation device according to formula (8):
$${x}_{SVS , ref , I} = \frac{{u}_{svs , I}^{2}}{{q}_{SVS , ref}} \qquad ( 8 )$$
calculating an equivalent reactance x_{SVS,I} of the static reactive power compensation device according to formula (9):
$${x}_{SVS , I} = \frac{{x}_{SVS , ref , I}}{1 + {T}_{SVS} \cdot s} \qquad ( 9 )$$
where T_{SVS} represents a time constant determined by the controller parameters of the static reactive power compensation device;
calculating a reactive power q_{SVS,I} of the static reactive power compensation device according to formula (10):
$${q}_{SVS , I} = \frac{{u}_{SVS , I}^{2}}{{x}_{SVS , I}} \qquad ( 10 )$$
obtaining the output power of the static reactive power compensation device under the normal state according to a formula of s_{SVS,I}=jq_{SVS,I}, in which the power s_{SVS,I} is a component of s_{I}.

9. The simulation apparatus according to claim 8, wherein the processor is configured to solve a quasi-steady model of a device under the protection state by:
obtaining a protection start preparation time of the device, wherein an initial value of the protection start preparation time is 0, the protection start preparation time is added to a time interval if a terminal voltage of the device is greater than an upper limit or is less than a lower limit, and the protection start preparation time period is set as 0 if the terminal voltage of the device is between the an upper limit and the lower limit;
determining that the device is tripping, and setting the output power of the device as 0, if the protection start preparation time is greater than a predetermined time period.

10. The simulation apparatus according to claim 6, wherein a simulation period is set as ten milliseconds.

11. A non-transitory computer-readable storage medium having stored therein instructions that, when executed by a processor of a computer, causes the computer to perform a simulation method for a wind farm common coupling region, the simulation method comprising:
obtaining main network data calculated in a previous simulation period as initial values for performing a main network simulation in a current simulation period, in which the main network data comprises active powers and voltage amplitudes of generators of PV nodes, active powers and reactive powers of generators of PQ nodes, active powers and reactive powers of loads and voltage amplitudes and phase angles of balance nodes;
obtaining sub-network data of a sub-network corresponding to each wind farm which is calculated in the previous simulation period as initial values for performing a sub-network simulation in the current simulation period, in which the sub-network data of the sub-network corresponding to each wind farm comprises terminal voltage amplitudes of wind turbines and static reactive power compensation devices in each wind farm;
performing the main network simulation and the sub-network simulation in parallel in the current simulation period according to the initial values for performing a main network simulation and the initial values for performing a sub-network simulation.
